(19) United States
(12) Patent Application Publication
(10) Pub. No.: US 2026/0051265 A1
(43) Pub. Date: Feb. 19, 2026

(54) SIMULATION DEVICES FOR BREAST POSITIONING AND MAMMOGRAPHY TRAINING

(71) Applicant: One World Design and Manufacturing Group Inc., Whitehouse Station, NJ (US)

(72) Inventor: Erica McCarthy, Highbridge, NJ (US)

(73) Assignee: One World Design and Manufacturing Group Inc., Whitehouse Station, NJ (US)

(21) Appl. No.: 19/301,506

(22) Filed: Aug. 15, 2025

Related U.S. Application Data
(60) Provisional application No. 63/684,721, filed on Aug. 19, 2024.

(51) Int. Cl. G09B 23/28

(52) U.S. Cl. CPC G09B 23/286

(57) ABSTRACT

A mammography training simulation device, methods of use, and systems are provided. The device includes a wearable adjustable vest portion and a breast portion. The breast portion is attached to the wearable adjustable vest portion. The breast portion includes life-like human breasts that simulate the mechanical properties of human breast tissue thus providing realistic devices, methods, and systems that are useful for mammography training.

### CROSS REFERENCE TO RELATED APPLICATION

This application claims priority of U.S. Provisional Application Ser. No. 63/684,721 entitled “SIMULATION DEVICES FOR BREAST POSITIONING AND MAMMOGRAPHY TRAINING”, filed Aug. 19, 2024, the disclosure of which is incorporated herein by reference in its entirety.

This invention was made with government support under Award Number R43CA257792 awarded by the National Cancer Institute of the National Institutes of Health. The government may have certain rights in the invention.

### FIELD OF THE INVENTION

A mammography is a specialized medical imaging technique that uses low-dose X-rays to examine the human breast. It is primarily used as a diagnostic and screening tool to detect and evaluate breast tissue abnormalities, such as tumors or cysts, which may indicate the presence of breast cancer.

Typically, the patient is asked to remove clothing from the waist up and wear a gown. Any jewelry or accessories that could interfere with the imaging are also removed. The patient stands in front of a mammography machine, and each breast is placed, one at a time, on the imaging receptor. While the breast is manually held in position, a clear plexiglass paddle compresses and spreads the breast tissue so that X-rays traverse a thinner layer of tissue, thereby creating a better image. Positioning of the entirety of the patient's breast is critical for obtaining accurate and usable results. This procedure includes not only the central breast portion and nipple but also the lateral, medial, axillary, and inframammary breast tissue.

The mammography machine then takes X-ray images of the breast from different angles, usually from the top (craniocaudal view) and from the side (mediolateral oblique view). It is important to note that the patient's breast(s) needs to be repositioned manually by the technologist for each view. The compression may cause some discomfort, but it only lasts for about 20-30 seconds. The images are then examined by a radiologist, who looks for any signs of abnormalities, such as masses, calcifications, or asymmetrical areas.

To perform mammography, one must undergo specialized training and meet certain educational and certification requirements. After completing a radiologic technologist program, they must pass the American Registry of Radiologic Technologists certification exam. Obtaining advanced certification in mammography from a recognized body involves passing a specialized exam and fulfilling clinical experience requirements.

Ideally, technologists are trained to be proficient in operating mammography equipment and understanding imaging techniques, have an in-depth knowledge of breast anatomy and pathology, exhibit skills in patient communication, comfort, and care, particularly in positioning patients for mammograms, demonstrate ability to produce high-quality images in order to identify abnormalities, and understand radiation safety, privacy laws, and healthcare regulations

Even when educated and certified, often mammographers do not have the opportunity to practice positioning techniques until they serve actual patients as part of their clinical rotation. The lack of hands-on training often leads to improper placement of the breasts within the imaging field, resulting in missed tissue or inferior quality images. When the position of the breast does not meet ACR standards of proper positioning, including nipple profile, the images fail, and the patient must return for a repeat mammogram. These retests may not be scheduled for a week or more, thus leading to significant patient anxiety, delayed diagnosis of serious or life-threatening medical conditions, additional cost, and unnecessary waste of medical resources.

Thus, there is a significant need for realistic, safe, comfortable, and effective training devices, methods, and systems for mammography technologists to become better equipped to properly position both average and challenging breasts prior to performing mammography exams on actual patients. To this end, One World Design and Manufacturing Group has designed and developed the Mammovest® product line.

### SUMMARY OF THE INVENTION

The present disclosure is directed to mammography training devices comprising a wearable vest having a plurality of simulated life-like human breasts. The simulated life-like human breasts are realistically mobile and respond substantially similar to human breast tissue during breast positioning, palpation, and compression.

In non-limiting aspect of the present invention, a mammography training simulation device has a wearable adjustable vest portion and a breast portion. The breast portion being attached to the wearable adjustable vest portion.

In some embodiments, the breast portion includes a simulated skin layer.

In other embodiments, the simulated skin layer has a Shore OO Durometer hardness of between about 0 and about 30.

In certain embodiments, the breast portion is comprised of a silicone polymer.

In other embodiments, the breast portion includes an area of simulated lateral tissue, an area of simulated axillary tissue, an area of simulated pectoral muscle, an area of simulated connective tissue, an area of simulated breast tissue, and a simulated posterior chest layer.

In certain embodiments, the breast portion includes a plurality of simulated human breasts.

In certain embodiments, each of the plurality of simulated human breasts includes a nipple portion and an areola portion.

In typical embodiments, the wearable adjustable vest portion includes an apron portion, a central portion, and two shoulder portions.

In some embodiments, the vest portion has an apron portion, a central portion, and two shoulder portions. The apron portion includes a first hook and loop fastener portion for attachment of a pair of wrap around straps. The pair of wrap around straps each includes corresponding second and third hook and loop fastener portions. The central portion is connected to a first strap and an adjustable first buckle. The first strap can be attached to the adjustable first buckle, thereby allowing the first strap to be secured about a wearer's torso. The two shoulder portions are each attached to a second strap. Each of the second straps has a strap slider. Each strap slider can be used to adjust the length of each of the second straps to fit the wearer. A distal portion of each second strap is attached to the pair of wrap around straps and to a cross strap. The cross strap includes a cross buckle for connecting the cross strap across the wearer's back. The pair of wrap around straps can be secured around the wearer's waist by fastening the second and third hook and loop portions of the wrap around straps to the first hook and loop portion of the apron portion.

In certain embodiments, the simulated human breast portion can include simulated implants.

In a particular embodiment, the breast portion includes small breasts having a cup size between about an A cup and about a B cup.

In some embodiments, the device can include a simulated belly.

In other embodiments, the breast portion includes large pendulous breasts having a cup size between about an F cup to G cup.

In another non-limiting aspect, a mammography training simulation device has a wearable adjustable vest portion. The wearable adjustable vest portion includes an apron portion, a central portion, and two shoulder portions. A breast portion can be attached to the wearable adjustable vest portion.

In another embodiment of this aspect, the breast portion includes a simulated skin layer.

In some embodiments, the simulated skin layer has a Shore 00 Durometer hardness of between about 0 and about 30.

In certain embodiments, the breast portion includes an area of simulated lateral tissue, an area of simulated axillary tissue, an area of simulated pectoral muscle, and area of simulated connective tissue, an area of simulated breast tissue, and a simulated posterior chest layer.

In other aspects, a method of using a mammography training simulation device can include the step of fitting a wearer with a mammography training simulation device. The device having a wearable adjustable vest portion and a breast portion. The breast portion being attached to the wearable adjustable vest portion and having at least one simulated breast.

In a particular embodiment, the method of using a mammography training simulation device can include the steps of securing the wearable adjustable vest portion around the wearer's torso using a first buckle and a first strap; adjusting a pair of shoulder straps using a pair of strap sliders; connecting a cross strap using a second buckle; wrapping a pair of straps around the wearer's hips; and securing the pair of straps to a front portion of the wearable adjustable vest portion using a hook and looper fastening system.

In certain embodiments, a method of using a mammography training simulation device can include the steps of: holding a breast portion above and on top of the wearer's own breasts; securing the wearable adjustable vest portion around the wearer's torso using a first buckle and a first strap; raising a second and third strap over the wearer's head and each shoulder and adjusting the shoulder strap lengths using strap sliders; connecting the shoulder straps using a fourth strap and second buckle; wrapping a pair of hook and loop straps around the wearer's hips; securing the pair of straps to a front portion of the wearable adjustable vest portion using a hook and looper fastening system; and releasing the breast portion.

In some embodiments, a method of using a mammography training simulation device can include the steps of lifting a simulated breast; pulling the simulated breast onto an image detector; and lowering a compression paddle to compress the simulated breast.

In one embodiment, the method of using a mammography training simulation device further includes the steps of standing to the side of the simulated breast to be imaged; adjusting a mammography machine based on a patient height; elevating the simulated breast with a first hand; lifting the simulated breast with a second hand until the posterior nipple line is perpendicular to a chest wall with a second hand; pulling the simulated breast onto a detector; sliding the first hand out while anchoring the simulated breast with a second hand; grabbing the lateral tissue and pulling forward; switching hands to anchor the simulated breast; inspecting the side for inclusion of all medial tissue; lowering a compression paddle; applying compression; and confirming the breast would be ready for imaging in a cranial caudal (CC) view.

In yet other embodiments, the method of using a mammography training simulation device further includes the steps of: determining the obliquity of a patient's pectoral muscle; rotating a C-arm of a mammography machine to be parallel to the pectoral muscle; finding a mid-axillary line; positioning the patient; using a first hand to do a breast sweep back to the mid-axillary line; performing a bi-manual pull with the first hand and a second hand, lifting tissue up; sliding the first hand towards a nipple; ensuring the nipple is in profile; anchoring the breast; inspecting to ensure the light field at the edge of the sternum and just below clavicle and the shadow of an inframammary fold is visible on IR; sliding a hand towards the nipple while applying compression; pulling the patient's abdomen down to remove any excess abdominal tissue; inspecting for any shadowing; and confirming the breast would be ready for imaging in a mediolateral oblique (MLO) view.

In addition to simulating proper positioning, the mammography training devices described herein can be utilized to 1) show corrective positioning; for example, removing skin folds or correcting air gaps that naturally occur during breast positioning, even when done correctly 2) demonstrate poor positioning, e.g. identifying common mistakes and corrective action during positioning that are ideally suited for demonstrating on mammography training device rather than a human patient and 3) educate technologists on body mechanics to avoid workplace injury, for example, teaching proper posture, neck alignment, wrists in neutral position during patient positioning for a mammogram.

In another aspect, a system for mammography training includes a mammography training simulation device including a wearable adjustable vest portion and a breast portion. The breast portion being attached to the wearable adjustable vest portion. A curriculum can include a user manual, facilitator guides, instructional slide decks, use case scenarios, standardized simulation scenarios by patient type, interactive modules, posters, reference cards and a set of videos. The set of instructions and video tutorials describe how to use the instant invention as a training tool to demonstrate proper and improper breast positioning so that trainees can gain the skills to produce safe and accurate mammograms.

In certain embodiments, the system can include a tautness puck shaped in the form of a compressed breast. The puck can function as a palpation reference as part of the simulator system. The puck can have a compression level of between about 3.2 cm and about 5.2 cm thereby simulating human breast tissue comprised of about 50% fatty tissue and about 50% glandular tissue.

### DESCRIPTION OF THE DRAWINGS

FIG. 1 depicts an isometric front view of a mammography training device in accordance with one non-limiting embodiment of the present invention;

FIG. 2 depicts an isometric view of a simulated breast portion of a mammography training device in accordance with one non-limiting embodiment of the present invention being attached to a torso;

FIG. 3 shows another isometric view of a simulated breast portion of a mammography training device in accordance with one non-limiting embodiment of the present invention;

FIG. 4 depicts a front view of a vest portion of a mammography training device in accordance with one embodiment of the present invention;

FIG. 5 depicts a rear view of some of the elements of a vest portion in accordance with an embodiment of the present invention;

FIG. 6 depicts a front view of some of the elements of a mammography training device in accordance with one non-limiting embodiment of the present invention;

FIG. 7 depicts another front view of a mammography training device in accordance with one non-limiting embodiment of the present invention;

FIG. 8. depicts an isometric front view of a mammography training device being worn by a user in accordance with one non-limiting embodiment of the present invention; and

FIG. 9 depicts a front view of the simulated breast portion and vest portion of a mammography training device in accordance with one non-limiting embodiment of the present invention.

### DETAILED DESCRIPTION OF THE INVENTION

Devices featuring life-like breasts and soft, natural-feeling skin that can mimic the mobility and the response of human breast tissue during positioning, compression, and palpation for practicing mammography positioning are provided. The devices can be wearable and can be used to simulate realistic clinical experience thus allowing opportunities for repetitive practice without patient discomfort. These devices eliminate limitations due to live models' discomfort, willingness, and availability and provide confidence for mammography technologists in both early training and skills maintenance.

The simulation models disclosed herein are useful for breast positioning during mammography training and are designed to be inclusive of the patient population with clinically relevant morphologies. In addition to typical morphology, simulation model improvements can include other morphologies which are common but challenging to position such as those for augmented breasts (implants), small breasts with a protruding belly, and large pendulous breasts.

Utilizing novel casting techniques based on research and development of the standard morphology, additional common breast morphologies can be evaluated by expert mammography positioning specialists for functional realism during positioning and compression.

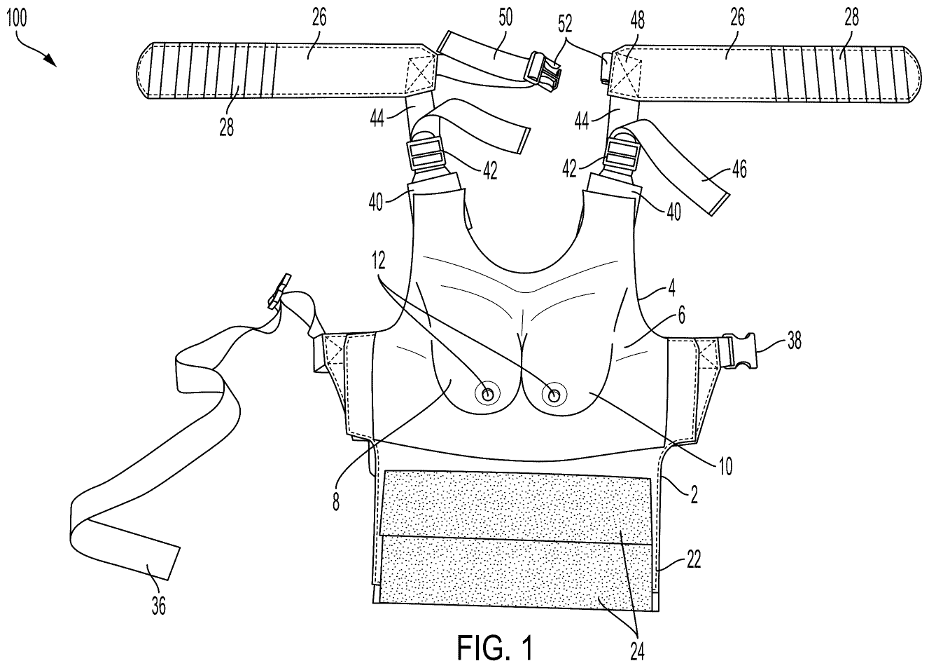

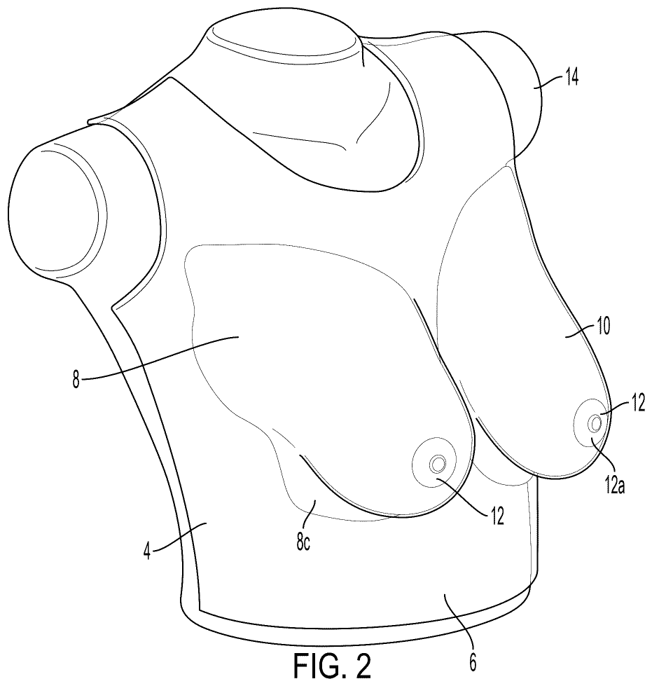

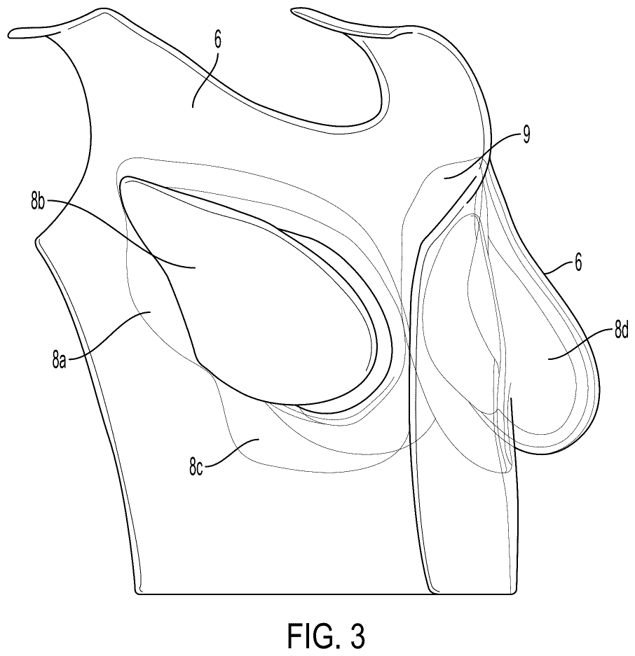

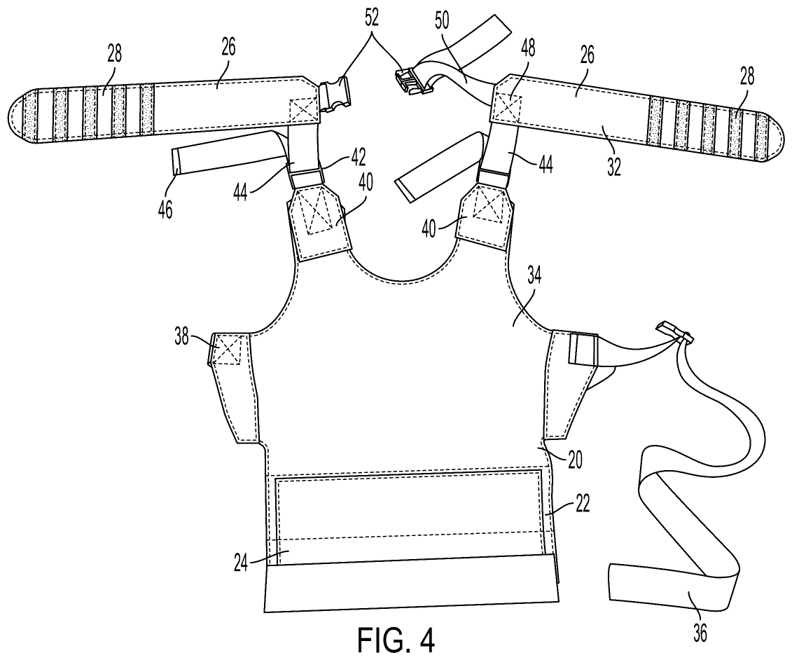

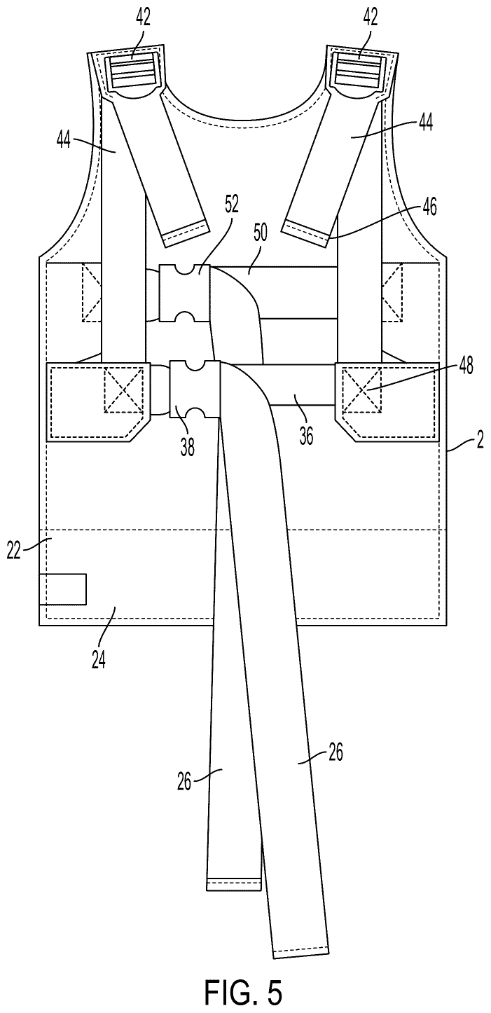

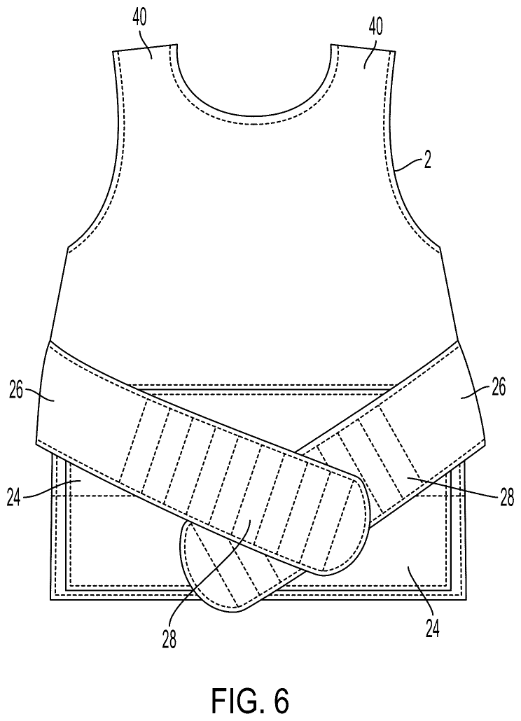

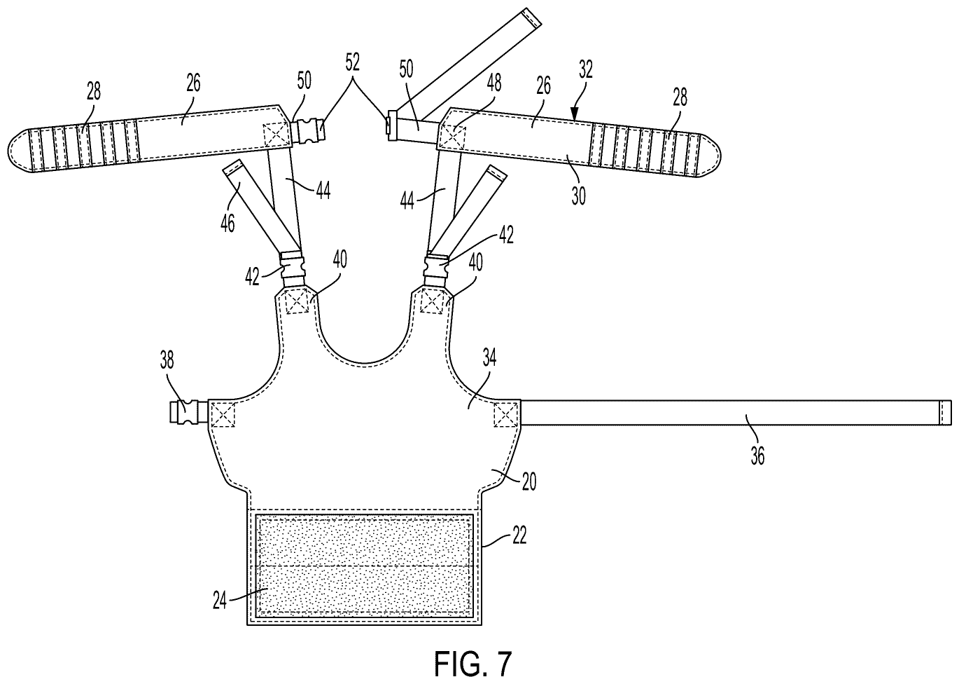

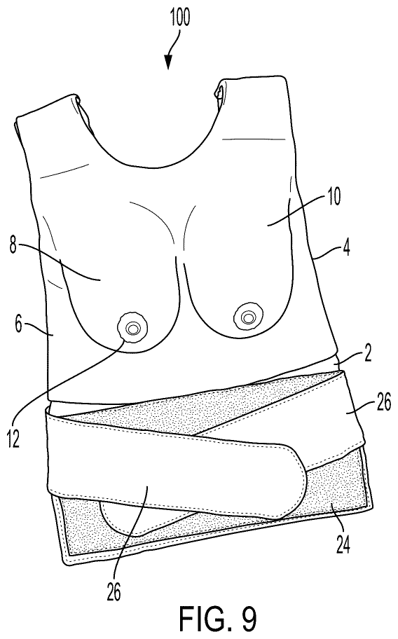

Referring to FIGS. 1-9, a mammography training simulator device 100 includes a wearable adjustable vest portion 2 having simulated human breast portion 4 attached thereto. The breasts portion 4 is designed to include soft, natural-feeling skin 6 that mimics human breast tissue, and a plurality of simulated life-like human breasts 8,10. The simulated life-like human breasts 8,10 (hereinafter breasts or simulated breasts) are designed to respond mechanically to simulate human breast tissue during the steps involved in positioning the breast for mammography (e.g. simulated breast movement, pulling, smoothing, compression and palpation). The simulated breasts 8,10 can include a nipple portion 12 having an areola 12a.

The simulated breast portion 4 can include skin 6, simulated breasts 8, 10 lateral tissue 8a, simulated pectoral muscle 8b, simulated facia and connective tissue 8c, simulated breast tissue 8d, and a simulated posterior chest layer 9.

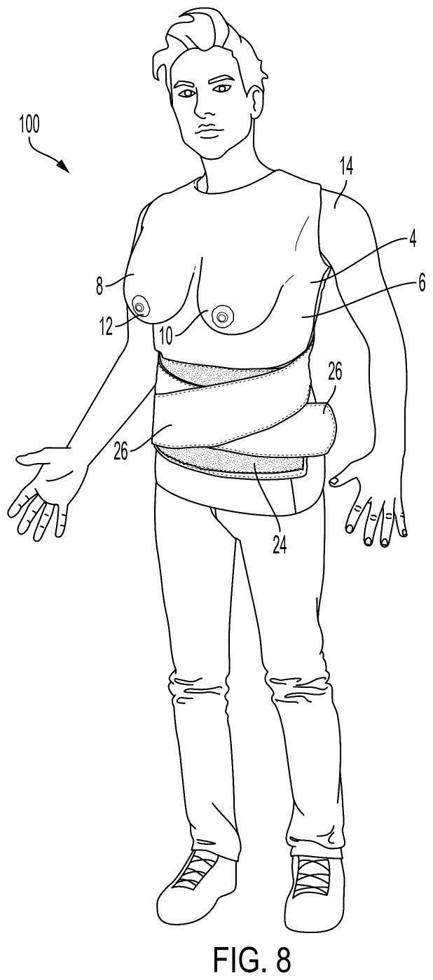

The device 100 can be adjustably and removably mounted such that the vest portion 2 supports the breast portion 4 when worn by a simulated patient about their torso 14 during training on breast positioning for mammography. See e.g., FIG. 8.

The vest portion 2 includes an area 20 having an apron portion 22. The apron 22 includes a hook and loop fastener portion 24 for attachment of wrap around straps 26 which include corresponding hook and loop fastener portions 28. The wrap around straps 26 can include hook and loop fasteners on both an outer surface 30 and an inner surface 32 thus allowing the wrap around straps 26 to be fastened to the hook and loop fastener portion 24 and to each other.

An area 20 includes a central portion 34 attached to a first strap 36. The first strap 36 can be attached to an adjustable first buckle 38. Any suitable means of adjustable strap and buckle can be used to secure the first strap 36 to the first buckle 38 about a wearer.

The area 20 includes two shoulder portions 40. Each of the shoulder portions 40 is attached to a strap slider 42. The strap slider 42 can be used to adjust the length mated of second strap 44 by changing the length of proximal end 46 of second strap 44. A distal portion 48 of second strap 44 is attached to wrap around strap 26 and cross strap 50. Cross strap 50 includes complementary mating second buckles 52 used to connect the cross strap 50 across a wearer's 14 back. Wrap around straps 26 are attached to the distal portion 48 of second straps 44 thus allowing the wrap around straps 26 to be secured around a wearer's 14 waist and fastened to the hook and loop portion 28 of the wrap around straps 26 to be attached to the hook and loop portion 24 of the vest portion 2.

The vest portion 2 can be attached to the breast portion 4 using an adhesive layer (not shown). The breast portion 4 covers only a part of the vest portion 2, thus allowing for attachment of the wrap around straps 26 to the apron 22 using the hook and loop fastener portions 24, 28.

The different cups sizes discussed herein are estimated for general reference and will be known to a person of ordinary skill in the art of breast health. Cup sizes cannot be described precisely as they are calculated based on band size, which is adjustable on the vest portion.

In a particular embodiment, the breasts 8, 10 can include implants (not shown) to simulate patient's breasts having breast implants. The implants can be silicone implants. The breasts 8, 10 can be made using an embedded casting process and can include a plurality of layers. The breasts 8, 10 and skin 6 can be made from silicone rubber. The hardness of the breasts 8, 10 and skin 6 can be in the range of from about 0 to about 30 Shore 00 durometer.

In some embodiments, there can be an exterior skin and internal chest layer, one or two internal layers, and a layer representing the pectoralis muscle and an option for the simulated implants.

In some embodiments, the breast portion 4 includes features for A cup size or small breasts. The device 100 can utilize one or more of A cup sized breasts 8,10 an attachable distended belly, or a difficult inframammary hold (IMF).

In other embodiments, the breast portion 4 can include features for large pendulous breasts 8, 10 (e.g., F cup, G cup or larger). The breast portion of the device 100 can include broad flaccid breasts 8,10.

Another non-limiting aspect of the present invention includes a breast positioning method mammography training simulator device. The method can include breast positioning training for at least the four breast morphologies, i.e. standard breasts, augmented breasts, large pendulous breasts and small breasts with a protruding belly in one or more of a craniocaudal (CC), a lateral-medial oblique (MLO), a lateromedial (LM), a mediolateral (ML) or a laterally exaggerated craniocaudal (XCCL) view and any other required view.

The simulation tool for breast positioning can improve breast positioning and training techniques through several innovative features. The devices 100 include simulated breasts which have realistic feel and maneuverability. The breasts 8, 10 are designed with skin and filler materials that can provide a true-to-life look and feel as well as realistic mobility so that they can be maneuvered and compressed for mammography similar to real breasts. Current technology includes rigid skin, immobile breasts, anatomical omissions, and general construction which prevent proper positioning and realistic compression for mammography. The methods herein are used for creating an effective tool for training technologists on breast positioning in preparation for accurate and efficient breast imaging.

The devices and methods allow for training on patient instruction. Unlike other simulators, the instant invention is designed to be comfortably worn by simulated patients. The novel devices allow mammography trainees to practice guiding and instructing patients on how to stand, where to place their arms, how to tilt their hips, and which way to turn their head. These factors have significant effect on ability to achieve good images. A wearable vest having realistic simulated breasts attached offers the chance to practice methods for effective communication without the need to use the actual breasts of the simulated patient. The vest includes a fabric portion and straps to fit a wide range of users.

In some embodiments a method for using a mammography training device 100 includes the steps of: holding the simulated breasts 8, 10 above and on top of a wearer's 14 own breasts during fitting; adjusting the straps 26, 36, 44, 50 to fit from the rear of the vest 2; securing the vest 2 around the wearer's 14 torso using a first buckle 38 included on a first strap 36; connecting second straps 44 using a strap slider 42 wherein the length of the second straps 44 can be adjusted depending on the wearer's body size; connecting cross straps 50 using a second buckle 52 wherein the length of the third straps 50 can be adjusted depending on the wearer's 14 body size; wrapping the wrap around straps 26 around the wearer's 14 hips from the back to mate with front hook and loop portions 24; and holding the front vest portion 2 to secure the hook and loop portions 24, 28 snuggly and support the weight of the vest 2, wherein the simulated breast 8,10 is positioned for mammography exam.

In certain embodiments a method of positioning for a craniocaudal (CC) mammography view including the steps of: fitting a patient with a mammography training simulator device 100 having a wearable adjustable vest portion 2 and a simulated human breast portion 4 including two simulated breasts 8, 10 attached thereto; standing the side of a simulated breast to be imaged; adjusting a mammography machine based on a patient height; elevating a simulated breast 8, 10 with a bottom hand having a pinky edge in an inframammary crease; lifting the simulated breast 8,10 until a posterior nipple line is perpendicular to the chest wall; using a bi-manual pull to bring breast tissue straight forward onto the detector; sliding the top hand out while anchoring the simulated breast 8,10 with a top hand; grabbing lateral tissue and pulling forward with the bottom hand; switching hands to anchor and inspect a medial side of the simulated breast 8, 10 for inclusion of all of the medial breast tissue; ensuring no air gap is present; lifting up on the skin 6 as a compression paddle comes down; positioning the patient's arm with the patient's shoulder externally rotated; checking for superimposed objects in the mammography beam path; and applying compression with the compression paddle, wherein the patient 14, wearing the device 10 is in an optimum position for breast imaging.

A simulation training system can include a standardized simulator created to advance initial mammography machine operator training, support continuing education efforts, and to improve the reaccreditation rates of breast imaging centers.

A system can include a standardized, hands-on curriculum for breast positioning. The system can include a complete downloadable curriculum with didactic instructions and videos describing how to achieve proper breast positioning. The curriculum can include details on the associated performance metrics as defined by the American College of Radiology as well as instructions on how to eliminate common mistakes. The combination of the curriculum and specific morphology simulation device 100 can provide a novel standardized training system for breast positioning. The curriculum can include a downloadable initial training curriculum and a continuing education training curriculum.

In one embodiment of the present invention a tautness puck can be shaped in the form of a compressed breast. The puck can function as an optimal palpation reference as part of the simulator system. Material properties (e.g., silicone and other elastomers) can be tailored in terms tensile feedback and durometer hardness to simulate the feel of breast skin under taut fixed compression. According to the American College of Radiology's metrics for proper breast positioning, the breast should be taut under compression. For the average breast, which is defined as 50% fatty and 50% glandular tissue, this level of compression is achieved at approximately 4.2 cm. Tautness is palpated through a ‘tap test’ in which the operator's finger bounces back from the skin surface (in contrast with dimpling or puckering the skin).

Other novel features can include realistic mobility of the inframammary fold (IMF) (e.g. partially unattached internally thus allowing for more freedom to pull away from patient's torso and be realistically positioned), adjustable vest strap(s) and buckle designs, separate harnesses for support including a torso harness and a shoulder harness, tight adjustable fit of lateral skin tissue around vest torso, weight distribution position down the back and across the hips for additional support, and adjustability for fit of male and female individuals' sizes from XS-4XL.

Although the invention has been described and illustrated with respect to exemplary embodiments thereof, it should be understood by those skilled in the art that the foregoing and various other changes, omissions, and additions may be made therein and thereto, without parting from the spirit and scope of the present invention.

What is claimed is:

1. A mammography training simulation device comprising:
a wearable adjustable vest portion; and
a breast portion, the breast portion being attached to the wearable adjustable vest portion.

2. The mammography training simulation device of claim 1, wherein the breast portion includes a simulated skin layer.

3. The mammography training simulation device of claim 2, wherein the simulated skin layer has a Shore OO Durometer hardness of between about 0 and about 30.

4. The mammography training simulation device of claim 1, wherein the breast portion is comprised of a silicone polymer.

5. The mammography training simulation device of claim 1, wherein the breast portion includes an area of simulated lateral tissue, an area of simulated axillary tissue, an area of simulated pectoral muscle, an area of simulated connective tissue, an area of simulated breast tissue, and a simulated posterior chest layer.

6. The mammography training simulation device of claim 1, wherein the breast portion includes a plurality of simulated human breasts.

7. The mammography training simulation device of claim 6, wherein each of the plurality of simulated human breasts includes a nipple portion and an areola portion.

8. The mammography training simulation device of claim 1, wherein the vest portion has an apron portion, a central portion, and two shoulder portions; the apron portion includes a first hook and loop fastener portion for attachment of a pair of wrap around straps, the pair of wrap around straps each includes corresponding second and third hook and loop fastener portions;
the central portion is connected to a first strap and an adjustable first buckle, the first strap can be attached to the adjustable first buckle, thereby allowing the first strap to be secured about a wearer's torso;
the two shoulder portions are each attached to a second strap, each second strap having a strap slider, wherein each strap slider can be used to adjust the length of each of the second straps to fit the wearer, a distal portion of each second strap is attached to the pair of wrap around straps and to a cross strap, the cross strap includes a cross buckle, wherein the cross strap can be secured across the wearer's back by mating the cross strap and the cross buckle and the pair of wrap around straps can be secured around the wearer's waist by fastening the second and third hook and loop portions of the wrap around straps to the first hook and loop portion.

9. The mammography training device of claim 1, wherein the simulated human breast portion includes simulated implants.

10. The mammography training device of claim 1, wherein the breast portion includes two small breasts having a cup size between about an A cup and about a B cup.

11. The mammography training device of claim 10, further including a simulated belly.

12. The mammography training device of claim 1, wherein the breast portion includes large pendulous breasts having a cup size between about an F cup and about a G cup.

13. A mammography training simulation device comprising:
a wearable adjustable vest portion, the wearable adjustable vest portion has an apron portion, a central portion, and two shoulder portions; and
a breast portion, the breast portion being attached to the wearable adjustable vest portion.

14. The mammography training simulation device of claim 13, wherein the breast portion includes a simulated skin layer.

15. The mammography training simulation device of claim 14, wherein the simulated skin layer has a Shore OO Durometer hardness of between about 0 and about 30.

16. The mammography training simulation device of claim 13, wherein the breast portion includes an area of simulated lateral tissue, an area of simulated axillary tissue, an area of simulated pectoral muscle, and area of simulated connective tissue, an area of simulated breast tissue, and a simulated posterior chest layer.

17. A method of using a mammography training simulation device including the step of:
fitting a wearer with a mammography training simulation device comprising
a wearable adjustable vest portion and a breast portion, the breast portion being attached to the wearable adjustable vest portion and having a simulated breast.

18. The method of claim 17 further including the steps of:
securing the wearable adjustable vest portion around the wearer's torso using a first buckle and a first central strap; adjusting a pair of shoulder straps using a pair of strap sliders; connecting a cross strap using a second buckle; wrapping a pair of straps around the wearer's hips; and securing the pair of straps to a front portion of the wearable adjustable vest portion using a hook and loop fastener system.

19. The method of claim 17 further including the steps of:
lifting the simulated breast; pulling the simulated breast onto an image detector; and
lowering a compression paddle to compress the simulated breast.

20. A system for mammography training system comprising:
a mammography training simulation device including a wearable adjustable vest portion and a breast portion, the breast portion being attached to the wearable adjustable vest portion; and
a downloadable curriculum, the curriculum including a set of instructions and a set of videos, wherein the set of instructions and the set of videos each describe how to achieve proper breast positioning using the mammography training simulation device thereby enabling a user to produce an accurate mammogram.
